(19) United States
(12) Patent Application Publication
(10) Pub. No.: US 2007/0100544 A1
(43) Pub. Date: May 3, 2007

(54) System for traffic circle navigation

(75) Inventor: Wataru Sugiura, Anjo-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/528,607

(22) Filed: Sep. 28, 2006

(30) Foreign Application Priority Data
Oct. 31, 2005 (JP) 2005-315747

(51) Int. Cl. G01C 21/00

(52) U.S. Cl. 701/211; 701/200

(57) ABSTRACT

A navigation system for navigating a vehicle toward a destination of a travel based on a detected current position includes an position detector for detecting a current position of the vehicle, and an information provision unit for providing navigation information for a user. The position detector detects a distance between the vehicle and a traffic circle, and, based on the current position of the vehicle detected by the position detector, the information provision unit provides for the user the navigation information that includes a size of the traffic circle when the distance between the vehicle and the traffic circle becomes equal to or smaller than a predetermined value.

### CROSS REFERENCE TO RELATED APPLICATION

This application is based on and claims the benefit of priority of Japanese Patent Applications No. 2005-315747 filed on Oct. 31, 2005, the disclosure of which is incorporated herein by reference.

### FIELD OF THE INVENTION

The present invention generally relates to a navigation system for use in a vehicle.

### BACKGROUND OF THE INVENTION

In recent years, a specific type of navigation system is used to navigate a vehicle that is traveling in a roundabout, or a traffic circle, in addition to providing route navigation toward a predetermined destination of a travel. The vehicle in or around the traffic circle is provided by the navigation system an exiting road from the traffic circle. For example, Japanese patent application No. JP-A-H11-72343 discloses a navigation system that notifies a user of the number of exiting roads from the traffic circle. Also, it is known to the public that a specific type of navigation system notifies the user of a relative angle of a exiting road against an entrance road based on an angle of the entrance road and an angle of the exiting road to and from the traffic circle.

However, the number of the exiting roads of the traffic circle and/or the direction of the exiting road relative to the entrance road do not provide for a driver of the vehicle a clue how far the exiting road really is. That is, the driver is left ill-informed about the remaining time for reaching the exiting road even when he/she is using the navigation system.

### SUMMARY OF THE INVENTION

In view of the above-described and other problems, the present disclosure provides a navigation system that provides for a driver of the vehicle a concrete idea about how soon the vehicle reaches an exiting road from the traffic circle when the vehicle is traveling in or toward the traffic circle.

In one aspect of the present disclosure, the navigation system for navigating a vehicle toward a destination of a travel based on a detected current position includes an position detector for detecting a current position of the vehicle, and an information provision unit for providing navigation information for a user. The position detector detects a distance between the vehicle and a traffic circle, and, based on the current position of the vehicle detected by the position detector, the information provision unit provides for the user the navigation information that includes a size of the traffic circle when the distance between the vehicle and the traffic circle becomes equal to or smaller than a predetermined value. In this manner, the user, or the driver of the vehicle, can have an idea how big the size of the traffic circle is. In addition, the navigation system provides the navigation information about an exiting road from the traffic circle. In this manner, the user can have an idea how soon the vehicle reaches a proper road that exits from the traffic circle onto a route toward the destination of the travel.

In another aspect of the present disclosure, the navigation system provides for the user the number of the branching roads before the user arrives at the exiting road. The navigation system also provides a circumferential travel distance of the traffic circle, and/or a diameter or the traffic circle for the user. In this manner, the user can have an idea that how soon the vehicle reaches a proper road that exits from the traffic circle onto a route toward the destination of the travel.

In yet another aspect of the present disclosure, the navigation system provides an illustrative graphic that represents the size of the traffic circle on a display unit, and/or provides a guidance voice that notifies the size of the traffic circle. In this manner, the user can have an idea that how soon the vehicle reaches a proper road that exits from the traffic circle onto a route toward the destination of the travel.

In yet another aspect of the present disclosure, the navigation system provides the size of the traffic circle for the user based on map data that includes link data and node data. That is, the navigation system calculates the size of the traffic circle by summing the distance of each link included in the traffic circle. In this manner, the size of the traffic circle can be provided for the user based on a conventional map data. In addition, when the map data includes the size of the traffic circles as additional attributes, the navigation system provides the size of the traffic circle by utilizing the size of the traffic circle included in the map data. In this manner, the calculation operation of the traffic circle size is eliminated.

### BRIEF DESCRIPTION OF THE DRAWINGS

Other objects, features and advantages of the present invention will become more apparent from the following detailed description made with reference to the accompanying drawings, in which:

FIG. 1 shows a block diagram of a navigation system in an embodiment of the present disclosure;

FIGS. 2A and 2B show data structure of link data and node data;

FIG. 3 shows an illustration of switches on a display unit;

FIG. 4 shows a flowchart of a part of a control process of the navigation system; and

FIG. 5 shows an illustration of links and nodes in and around a traffic circle.

### DETAILED DESCRIPTION OF THE PREFERRED EMBODIMENTS

Embodiments of the present disclosure are described with reference to the drawings. The embodiments of the present disclosure are not necessarily limited to the types/forms in the present embodiment, but may take any form of the art or technique that is regarded within the scope of the present disclosure by artisans who have ordinary skills in the art.

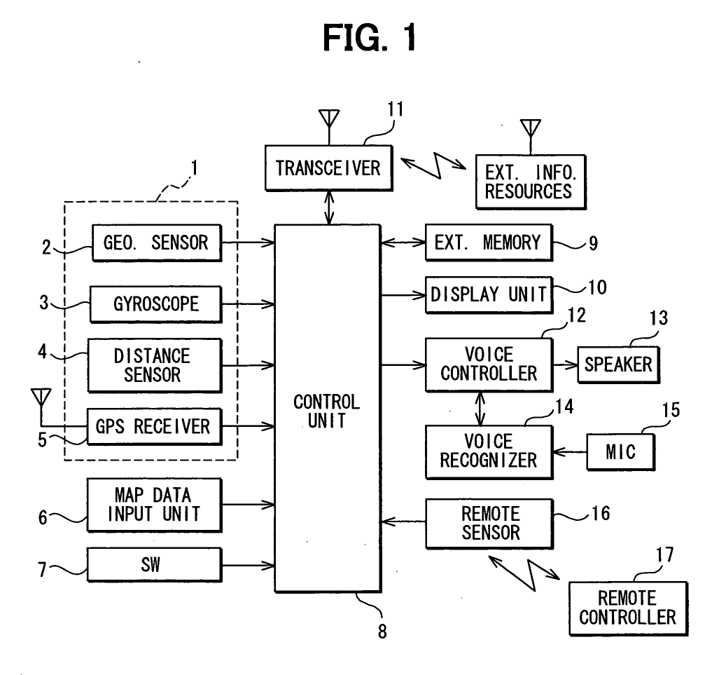

FIG. 1 shows a block diagram of a navigation system in an embodiment of the present disclosure. The navigation system includes a position detector 1, a map data input unit 6, operation switches 7, an external memory 9, a display unit 10, a transceiver 11, a voice controller 12, a speaker 13, a voice recognizer 14, a microphone 15, a remote sensor 16, a remote controller 17, and a control unit 8 for controlling each of the above devices.

The control unit 8 is a well-known type of computer that includes a CPU, a ROM, a RAM, an I/O and a bus line for connecting those components. The ROM stores a program that is executed by the control unit 8. The program controls processes and calculations conducted by the CPU.

The position detector 1 includes a plurality of well-known type sensors such as a geomagnetism sensor 2, a gyroscope 3, a distance sensor 4, and a Global Positioning System (GPS) receiver 5. The geomagnetism sensor 2 is used to detect a magnetic direction of a vehicle, and the gyroscope 3 is used to detect a relative bearing of the vehicle. The distance sensor 4 is used to detect a travel distance of the vehicle, and the GPS receiver 5 receives a radio wave from a GPS satellite for detecting a position of the vehicle. These sensors and/or receivers can compensate respectively different characteristics of inherent errors by interacting complementarily with each other. These sensors and/or receivers may selectively be used based on the accuracy of the output, and a steering rotation sensor, a speed sensor or the like (not shown in the figure) may additionally be utilized for compensation of the accuracy.

The map data input unit 6 is used to input digital map data such as road data, background drawing data, text data, facility data and the like. These data are provided by a memory medium such as a DVD-ROM, a CD-ROM (not shown in the figure). The map data input unit 6 retrieves these data from the DVD-ROM drive, the CD-ROM drive or the like connected thereto, and inputs them to the control unit 8. The map data in the memory medium includes links and nodes as road network data.

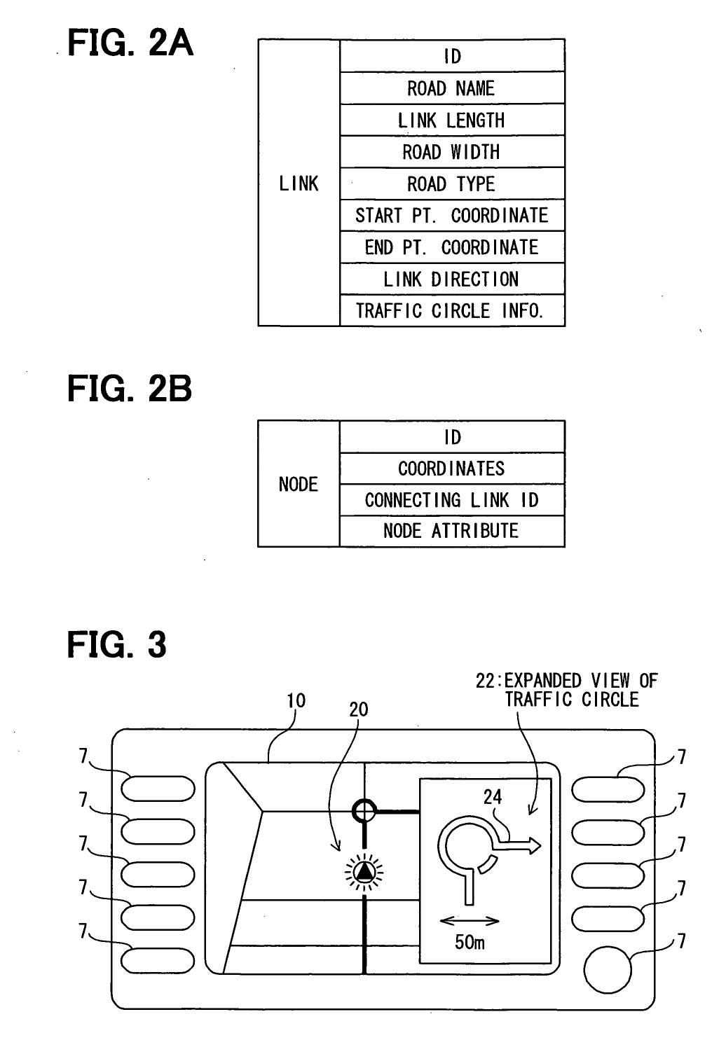

FIGS. 2A and 2B show data structure of link data and node data. The link and the node are respectively defined as a geometrical element (Link) with two end points (Node) attached on both ends of the element. Therefore, the node generally corresponds to a crossing, a branch point or the like of a road, and the link generally corresponds to a segment of the road between the two crossings or the like. In other words, roads in a real world are geometrically represented as a combination of the links and nodes. The link data includes a link ID, a road name, a link length, a road width, a road type such as a local road, an express road or the like, a start node coordinate, an end node coordinate, a link direction, and traffic circle information. The traffic circle information indicates inclusion of the link in a traffic circle. The node data includes a node ID, node coordinates (e.g., latitude and longitude), connecting link IDs for designating all the links that share the node as an end point, and node attribute that designates characteristics of the node such as an intersection with a stop sign, a branch point, a dead end or the like.

The operation switches 7 in FIG. 1 are disposed on, for example, the display unit 10 as touch switches, mechanical switches or the like, and are used for inputting various kinds of instructions for controlling road map on the display unit 10. The instructions for controlling the road map includes a map scale change instruction, a menu selection instruction, a destination setting instruction, a navigation start instruction, a current position correction instruction, a screen change instruction, a volume control instruction and the like.

The remote controller 17 has a plurality of switches (not shown in the figure) for inputting the same kind of instructions as the instructions from the operation switches 7. The remote controller 17 outputs control signals of instructions, and the control signals are provided for the control unit 8 through the remote sensor 16.

The external memory 9 is a memory medium, e.g., a memory card, a hard disk or the like, with read/write capability for storing data and/or information such as text data, image data, sound data as well as user information, e.g., a location of user's home and the like.

The display unit 10 is, for example, a liquid crystal display, an organic EL display or the like. The display unit 10 displays a position mark 20 (refer to the illustration in FIG. 3) of the vehicle at a current position in a map display area of the display 10 on top of the road map generated by using the map data. The display unit 10 also displays other information such as a current time, traffic congestion information or the like in addition to the vehicle position and the road map.

The transceiver 11 is a communication device for providing communication with external information sources for the control unit 8. For example, traffic information, weather information, date information, facility information and advertisement information are received from external information resources by using the transceiver 11. The information may be outputted from the transceiver 11 after processing in the control unit 8.

The speaker 13 is used to output a predetermined sequence of sound such as navigation guidance voice, screen operation guidance voice, voice recognition result or the like based on a sound output signal from the voice controller 12.

The microphone 15 converts user's voice to an electric signal that is inputted to the voice recognizer 14. The voice recognizer 14 recognizes the inputted user's voice for pattern comparison with vocabulary data in an internal recognition dictionary (not shown in the figure), and outputs most resembling vocabulary data to the user's voice as a recognition result to the voice controller 12.

The voice controller 12 controls the voice recognizer 14, and gives response to the user by providing talk back voice from the speaker 13. The voice controller 12 also controls the input of the recognition result of the voice recognizer 14 to the control unit 8.

The control unit 8 executes a predetermined process in response to the user's voice based on the recognition result of the voice recognizer 14, or in response to the user input from the operation switches 7 or from the remote controller 17. The predetermine process includes, for example, a map data storage process for storing the map data in the external memory 9, a map scale change process, a menu selection process, a destination setting process, a route search execution process, a route navigation start process, a current position correction process, a display screen change process, a volume control process and the like. Further, route navigation guidance information or the like processed in the control unit 8 is provided for the user from the speaker 13 in a suitable manner under control of the voice controller 12.

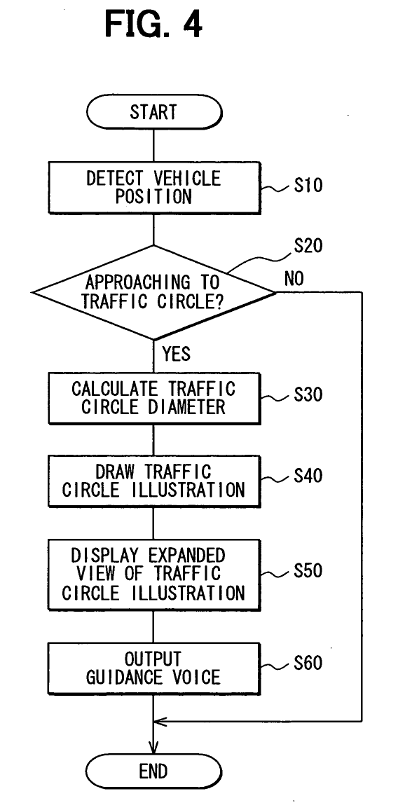

FIG. 4 shows a flowchart of a part of a control process of the navigation system. The flowchart describes the control process when the vehicle approaches the traffic circle. The control process repeats itself at a predetermined interval. The control process shown in FIG. 4 is executed in parallel with other processes such as a map update process, a voice guidance provision process at a predetermined timing and the like for route navigation.

The process starts with step S10. In step S10, the process determines a current vehicle position based on a signal from the position detector 1.

In step S20, the process determines whether the vehicle is approaching to the traffic circle. That is, the process determines whether the current vehicle position is within a predetermined distance from the traffic circle. The predetermined distance may be a few dozens of meters or the like. The process examines the proximity to the traffic circle by referring to the traffic circle information of the link data that belongs to the link in a predetermined distance ahead of the vehicle. The process concludes itself when the vehicle is not approaching to the traffic circle (step S20:NO). The process proceeds to step S30 when the vehicle is approaching to the traffic circle (step S20:YES).

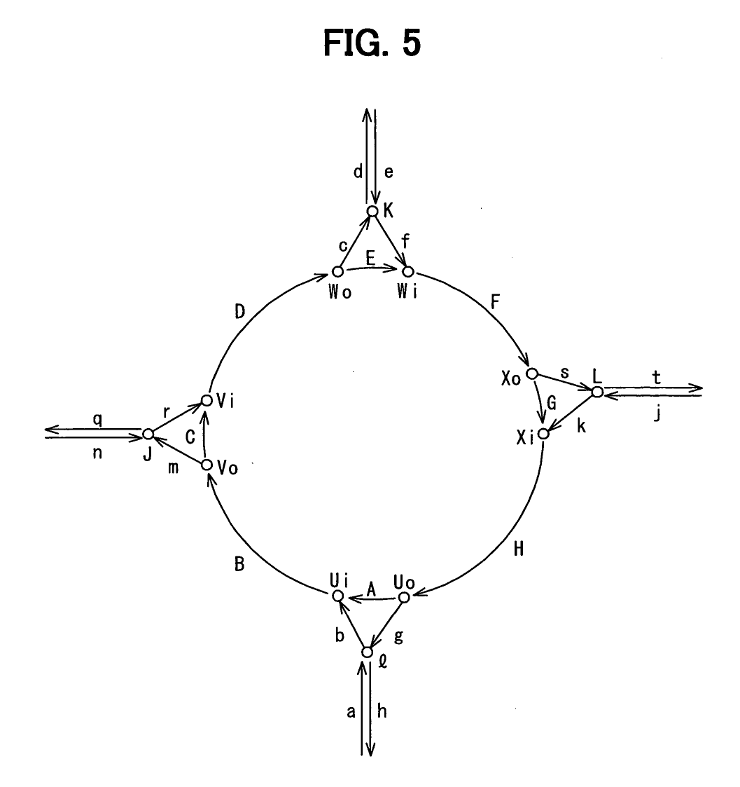

In step S30, the process calculates a diameter of the traffic circle by using the link data. FIG. 5 shows an illustration of links and nodes in and around the traffic circle. Traffic diameter calculation is described with reference to the illustration in FIG. 5. In FIG. 5, links A, B, C, D, E, F, G, H are the links with the traffic circle information that indicates the link belongs to a certain traffic circle, and nodes Uo, Ui, Vo, Vi, Wo, Wi, Xo, Xi are the nodes that belong to the same traffic circle. The nodes Ui, Vi, Wi, Xi are the nodes on entering links b, r, f, k that are used to enter the traffic circle. The nodes Uo, Vo, Wo, Xo are the nodes on exiting links g, m, c, s that are used to exit from the traffic circle. Start points of the entering links b, r, f, k are defined as nodes I, J, K, L, and end points of the exiting links g, m, c, s are also defined by the nodes I, J, K, L. In addition, the nodes I, J, K, L are the end points of two parallel links. That is, the node I is the end point of link a, and, at the same time, the start point of link h. Likewise, the node J is the end point of link n, and, at the same time, the start point of link q. The node K is the end point of link e, and, at the same time, the start point of link d. The node L is the end point of link j, and, at the same time, the start point of link t.

A total circumferential distance Ci of the traffic circle in FIG. 5 is calculated as a sum of the links A, B, C, D, E, F, G, H in the traffic circle. Further, a diameter R of the traffic circle is calculated by using the following equation.
R=Ci/π [Equation 1]

Now, in step S40, the process draws an traffic circle illustration 24 having an entering route and an exiting route based on a navigation route and the map data.

In step S50, as shown in FIG. 3, the process displays an expanded view 22 of the traffic circle illustration 24 at a timing of an exact moment of entering the traffic circle, or at a certain shifted timing before/after predetermined period of entrance to the traffic circle. The expanded view 22 on the display unit 10 includes a numeral that shows the diameter of the traffic circle accompanied by a two-headed arrow beside the traffic circle illustration 24.

In step S60, the process provides a guidance voice for the user from the speaker 13. The guidance voice for notifying the user of a size of the traffic circle and a direction of the exit relative to the entrance may sound “The vehicle is approaching to a traffic circle. Exit from the traffic circle having a diameter of 50 meters.”

The navigation system of the present disclosure provides a size of the traffic circle and an exiting direction from the traffic circle relative to an entering direction of the traffic circle, thereby enabling the user to easily recognizing how far and/or how soon the vehicle reaches an exit point. Further, the size of the traffic circle provides for the user an idea that how the user may maneuver the vehicle in the traffic circle.

Although the present disclosure has been fully described in connection with the preferred embodiments thereof with reference to the accompanying drawings, it is to be noted that various changes and modifications will become apparent to those skilled in the art.

For example, the size of the traffic circle may be provided as a circumferential distance of the traffic circle instead of the diameter of the traffic circle, or may be provided as a radius of the traffic circle.

Further, the diameter of the traffic circle may be stored and retrieved as diameter information from a memory in the map data input unit 6 instead of calculating it by summing the link length in the links in the traffic circle when the vehicle approaches the traffic circle.

Furthermore, the number of exit points or exit routes between the entering point and the exit point in the traffic circle may be notified to the user in addition to, or instead of, the exit direction relative to the entering direction. That is, as shown in FIG. 4, the number of the exit points is three when the vehicle enters into the traffic circle from the node I and exits from the traffic circle from the node L, because the vehicle exits from the traffic circle at the node Xo through the link s. Therefore, the guidance voice may sound “Exit from the third exit in 50 meters.” In this manner, the user of the navigation system can have a clearer idea of how to find an exit for exiting from the traffic circle when the size of the traffic circle and the number of the exit points between the entering point and the exit point are notified compared to only providing the number of the exit points for the user.

Such changes and modifications are to be understood as being within the scope of the present invention as defined by the appended claims.

What is claimed is:

1. A navigation system for navigating a vehicle toward a destination of a travel based on a detected current position, the navigation system comprising:
an position detector for detecting a current position of the vehicle, wherein the position detector detects a distance between the vehicle and a traffic circle based on the current position of the vehicle; and
an information provision unit for providing navigation information for a user, wherein, based on the current position of the vehicle detected by the position detector, the information provision unit provides for the user the navigation information that includes a size of the traffic circle when the distance between the vehicle and the traffic circle becomes equal to or smaller than a predetermined value.

2. The navigation system as in claim 1,
wherein the navigation information includes a location of an exiting road from the traffic circle toward the destination of the travel.

3. The navigation system as in claim 1,
wherein the navigation information includes a direction of an exiting road from the traffic circle relative to an entrance road to the traffic circle.

4. The navigation system as in claim 1,
wherein the navigation information includes a number of branching roads from the traffic circle between an entrance road to the traffic circle and an exiting road from the traffic circle toward the destination of the travel.

5. The navigation system as in claim 1,
wherein the size of the traffic circle is represented as a circumferential distance of the traffic circle.

6. The navigation system as in claim 1,
wherein the size of the traffic circle is represented as a diameter of the traffic circle.

7. The navigation system as in claim 1 further comprising:
a display unit for displaying an illustrative graphic,
wherein the size of the traffic circle is represented as the illustrative graphic on the display unit.

8. The navigation system as in claim 1 further comprising:
a sound output unit for outputting sound,
wherein the size of the traffic circle is vocally conveyed to the user.

9. The navigation system as in claim 1 further comprising:
a display unit for displaying an illustrative graphic; and
a sound output unit for outputting sound,
wherein the size of the traffic circle is represented as the illustrative graphic on the display unit and is vocally conveyed to the user.

10. The navigation system that utilizes map data of road network modeled with node data and link data having distance attribute for interdependently defining nodes as two end points of a link and a link as a road segment between two adjacent nodes in the road network as in claim 1, the navigation system further comprising:
a map data storage unit for storing the map data; and
a travel distance calculation unit for calculating a travel distance of the vehicle based on the map data stored in the map data storage unit,
wherein the size of the traffic circle in the navigation information is calculated by the travel distance calculation unit based on summation of the distance attribute of each of the links included in the traffic circle.

11. The navigation system that utilizes map data of road network modeled with node data and link data for interdependently defining nodes as two end points of a link and a link as a road segment between two adjacent nodes in the road network as in claim 1, the navigation system further comprising:
a map data storage unit for storing the map data with a size of each of the traffic circles,
wherein the size of the traffic circle in the navigation information is retrieved from the map data.
